(19) United States
(12) Patent Application Publication
(10) Pub. No.: US 2007/0239597 A1
(43) Pub. Date: Oct. 11, 2007

(54) System and method for optimizing mortgage application processing

(76) Inventors: Thinh Nguyen-khoa, Huntington Beach, CA (US); Binh Dang, Santa Ana, CA (US); David Dao, Anaheim, CA (US); Dominic Le, Westminster, CA (US); Brian Beery, Fountain Valley, CA (US)

Correspondence Address: IRELL & MANELLA LLP, 840 NEWPORT CENTER DRIVE, SUITE 400, NEWPORT BEACH, CA, 92660, US

(21) Appl. No.: 11/592,602

(22) Filed: Nov. 3, 2006

Related U.S. Application Data
(60) Provisional application No. 60/790,205, filed on Apr. 6, 2006.

(51) Int. Cl. G06Q 40/00

(52) U.S. Cl. 705/38

(57) ABSTRACT

A novel system and method for determining a qualified loan applicant is disclosed. In one embodiment, applicant information and potential first liens are compared to determine candidate first liens based on applicant information. Debt-to-income ratio requirement information associated with the candidate first liens is stored. Candidate second liens associated with the candidate first liens are determined, and the debt-to-income ratio of the combination of the candidate first and second liens is determined. Qualifying combinations are determined by comparing the debt-to-income ratio to the stored debt-to-income ratio requirement. In another embodiment, candidate first liens are organized by common characteristics and outputted with associated second liens. Other embodiments, such as optimizations on the system and method, are disclosed herein.

### CROSS-REFERENCE TO RELATED APPLICATIONS

This application claims priority to U.S. Provisional Patent Application No. 60/790,205, filed Apr. 6, 2006, the entirety of which is incorporated herein by reference.

### BACKGROUND OF THE INVENTION

1. Field of the Invention

The present application relates to the general field of digital mortgage systems and software and more particularly to mortgage systems and software for optimizing the selection of potential mortgages.

2. Prior Art

One typical method of financing a home purchase or a refinancing of an existing mortgage is to use one loan (typically referred to as a first lien) that amounts to 80% of the home value and/or purchase price and a second loan (typically referred to as a second lien) used for all or part of the remaining portion of the home value and/or purchase price. Such a financing package may allow the user to obtain a better interest rate on the first lien and/or avoid other costs, such as mortgage insurance due to having one loan that has a balance that is more than 80% of the home value. To facilitate the process of applying for and obtaining financing, typical present day mortgage systems and software of mortgage companies and/or mortgage brokers may use a computer network to select potential loans for a mortgage applicant. As used herein, the term broker may refer to any person using mortgage applications to obtain financing for him/herself and/or another mortgage applicant.

In a typical example, as shown in FIG. 1, a broker may input user data for use in determining potential loans (block 100). As an example of possible applicant data, FIG. 2 illustrates an applicant's name of John Applicant and other applicant information such as social security number, credit scores, etc. This information may be input via a software application installed on the broker machine or a web-based application. FIG. 3 illustrates other exemplary information typically received from a user such as the subject property, amount of the loan, home value, applicant's income and other information that is helpful in determining the applicant's loan qualifications.

In block 105, the applicant data is applied to all potential first lien programs that are available. Such programs are generally received from a variety of lenders and have different types of qualification requirements and information applicable to the loan. For example, possible first lien programs may include a 30 year fixed rate loan, a 30 year adjustable rate mortgage program that is fixed for 3 years, a 30 year adjustable mortgage program that is fixed for 10 years, or other type of loans such as interest only loan for 10 years. Each loan program would vary depending on the lender and qualifications of the applicant as is known in the art.

In block 110, the pricing and qualification for the available first lien programs is determined as shown in FIG. 4. For example, a monthly loan payment is calculated for each potential first lien. Also, qualification information such as the applicant's debt to income ratio (“DTI”) is calculated for each first lien. The DTI is usually calculated in terms of the applicant's monthly debt plus the additional proposed debt associated with the first lien monthly loan payment. This information may be stored for later use. In this example, potential programs may include 15 year fixed loans, a 30 year adjustable rate loan fixed for 2 years, and other loans.

In block 115, typical mortgage systems will display the potential second lien programs that are associated with a selected first lien program. As an example, in FIG. 4, the user has selected the 30 year adjustable rate mortgage program with a 3 year fixed interest rate (3/27 ARM IMPAC PRO). As shown in FIG. 4, once the first lien is selected, seventeen associated rates are calculated and displayed for the broker. In this example, the rate goes from 8.5% up to 10.5%. Each rate has a different point value and associated payment. Also, each rate results in a different DTI for that rate. For example, the 8.5% rate results in a DTI of 61.364%. As the rate increases, the payment, as well as the DTI increases. Using a software application, such as in FIG. 4, the broker can determine the desired rate that the potential borrower is looking for and also the potential payment to the broker, which is represented by the point value associated with the loan.

In block 115, the broker chooses to review the second liens associated with the first lien that has been selected. In the example in FIG. 4, the broker elects to view the second liens associated with the 9.625% rate, which are then shown in a new screen, such as in FIG. 5. FIG. 5 shows the associated second lien such as the 15 year fixed, 30 year fixed loan, etc.

In block 120, the rate, payment and point are calculated for the selected second lien. Also, the combined DTI is calculated for the selected first lien and for the displayed second liens. For the example in FIG. 5, the broker has selected to view more of the 30 FIXED 2ND IMPAC PRO second lien, which shows nine associated rates with that program. The rates start from 11.625% up to 12.625% and the payment, as well as the DTI, also increase accordingly.

Once the broker is able to view the potential second liens, he may select one of the programs based on the point and payment. In the example in FIG. 5, the broker has selected the second lien with a rate of 11.750% and an associated DTI of 78.702%.

At this point, the effect of the second lien monthly payment has not been evaluated. Thus, the broker must return to the first lien that was selected from FIG. 4 and recognize whether the DTI of the combined payment from the selected first and second lien violates any DTI condition of the first lien. For example, if the selected first lien does not allow for more than a 70% DTI, the broker in this example would have to evaluate the DTI of the combined payment to recognize that this violates the DTI condition for the 30 YR 3 YR ARM that was selected from FIG. 4.

Such a situation presents a problem for the broker because a violation of the DTI condition generally results in the lender requiring a rate adjustment for the first and/or second lien. This rate adjustment would increase the combined payment and would result in a new, higher DTI for the combined first and second lien payments. Thus, once the broker determines that the combined DTI violates the first lien's DTI condition, the rates and payments must be recalculated based on the new DTI and the broker must start all over again by re-selecting a new second lien to go with the new rate from the first lien.

Such a system is very inefficient and requires the broker to work by trial and error in determining the first lien, with its associated rate and fee, and the second lien, with its associated rate and fee, to find a combination that meets the DTI qualifications for both loans. Another limitation of the art is that the broker must review various screens from the mortgage software, such as FIGS. 4 and 5, and go back and forth between them to determine the final loans that the potential borrower(s) qualify for. Moreover, FIGS. 4 and 5 do not group together loans in an organized manner, such as based on common characteristics of the loan programs. It is very desirable to overcome these and other limitations in the art.

### BRIEF SUMMARY OF THE INVENTION

A computer usable medium having computer readable program code for determining a qualified loan applicant is disclosed. The program causes one or more computers to receive applicant information and receive first lien information. The program causes one or more computers to determine a candidate first lien by applying said applicant information to said first lien information. The program causes one or more computers to store debt-to-income-ratio requirement information associated with said candidate first lien. The program causes one or more computers to determine one or more candidate second liens associated with said candidate first lien. The program causes one or more computers to determine debt-to-income ratios of the combination of each candidate second lien with said candidate first lien. The program causes one or more computers to determine qualifying combinations based on whether each said debt-to-income ratio violates said stored debt-to-income-ratio requirement.

Other embodiments are more fully disclosed herein.

### BRIEF DESCRIPTION OF THE DRAWINGS

FIG. 1 illustrates how a broker may input applicant data for use in determining potential loans.

FIG. 2 illustrates an applicant's name and other applicant information.

FIG. 3 illustrates other exemplary information typically received from a user.

FIG. 4 illustrates how the pricing and qualification for the available first lien programs are determined.

FIG. 5 shows associated second liens.

FIGS. 6-7 illustrate a distributed network system according to aspects of the present invention.

FIG. 8 is an illustration of an exemplary embodiment of the present invention.

FIG. 9 illustrates an alternative method for improvement over the prior art.

FIG. 10 is an example of the output results of the mortgage service server.

FIG. 11 illustrates an exemplary embodiment for use in determining the qualifying first and second liens and determining the best rate and fee combinations for those liens.

FIG. 12 is an illustration of exemplary first and second liens with their associated rates, information, and fees that may be organized in terms of an array.

FIGS. 13-16 are illustrations of exemplary flowcharts from exemplary embodiments of the present invention.

FIGS. 17-34 are illustrations of exemplary first and second liens organized and evaluated according to embodiments of the present invention.

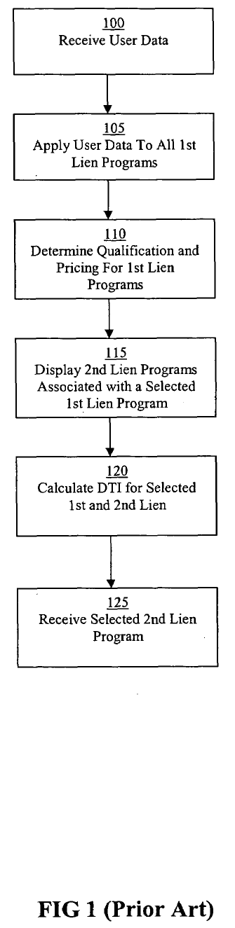

### DETAILED DESCRIPTION

Various aspects of the disclosure are described herein in the context of an apparatus, system, and method for optimizing mortgage application systems. Those of ordinary skill in the art will realize that the following description is illustrative only and not in any way limiting. Other aspects will readily suggest themselves to such persons having the benefit of this disclosure.

For example, any number of computer programming languages, such as the Java language, JavaScript, Java Applet technology, C, C++, Perl, Pascal, Smalltalk, FORTRAN, assembly language, HTML (i.e., Hypertext Markup Language), DHTML (i.e., Dynamic Hypertext Markup Language), XML (i.e., extensible Markup Language), XLS (i.e., extensible Style Language), SVG (i.e., Scalable Vector Graphics), VML (i.e., Vector Markup Language), Macromedia's Flash technology, and the like, may be used to implement aspects of the present invention. Further, various programming approaches such as procedural, object-oriented or artificial intelligence techniques may be employed, depending on the requirements of each particular implementation.

The same reference numbers will be used throughout the drawings and description in this document to refer to the same or like parts. Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory (such as, e.g., a floppy disk, CD, DVD, flash memory, hard disk, or RAM) that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems (such as, e.g., an ASIC or FPGA) which perform the specified functions or steps, or combinations of special purpose hardware and computer instructions.

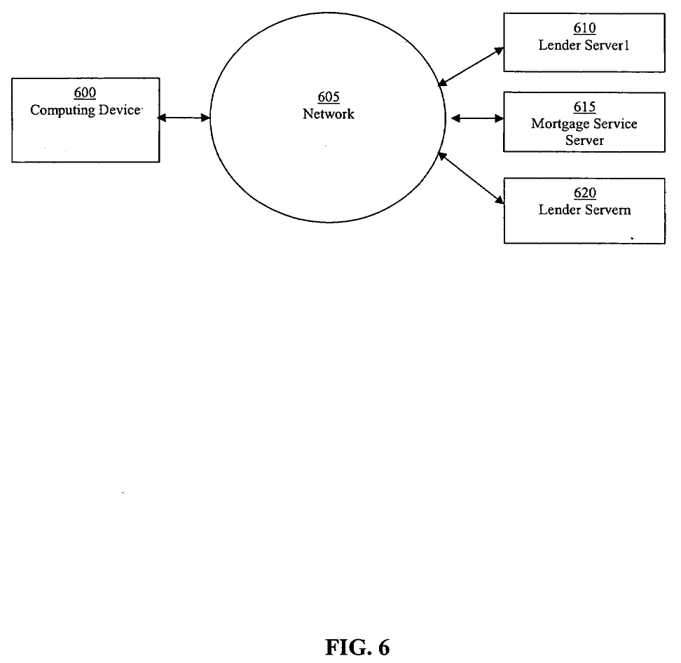

FIG. 6 illustrates a distributed network system according to aspects of the present invention. A computing device 600 is shown, connected to a network 605. Various servers are also connected to the network 605. For instance, a lender server1 610, a mortgage service server F15, and a lender servern 620 are all shown as being in communication with the network 605, although other servers (not shown) may also be connected to the network 605. The computing device 600 may be any type of device configured for computing, such as a personal computer, a mobile phone, a personal digital assistant, a navigation system located in a vehicle, and so on. The servers 610, 615 and 620 may each be any device capable of hosting services over the network 605, such as a network server or a web server. The servers 610, 615, and 620 may also be capable of determining and/or obtaining some or all mapping information based on user input. Alternatively, the computing device 600 may be equipped with the capability to determine some or all of the operations performed by the servers 610, 615, 620. In some implementations, the computing device and the servers (or various portions thereof) may be co-located in one or more machines.

The network 605 may be any type of distributed network, such as a local area network, wide area network, switched telephone network, Intranet, Internet or World Wide Web network. Alternatively, the network 605 may be a direct connection between the computing device 600 and the servers 610, 615, and 620. The computing device 600, network 605 and/or servers 610, 615, and 620 may be in communication. via any type of wired or wireless connection. Moreover, the computing device 600, the servers 610, 615, and 620, and other computing devices (not shown), and/or other servers (not shown) in communication with the network 605 may be used to perform any or all functions described herein.

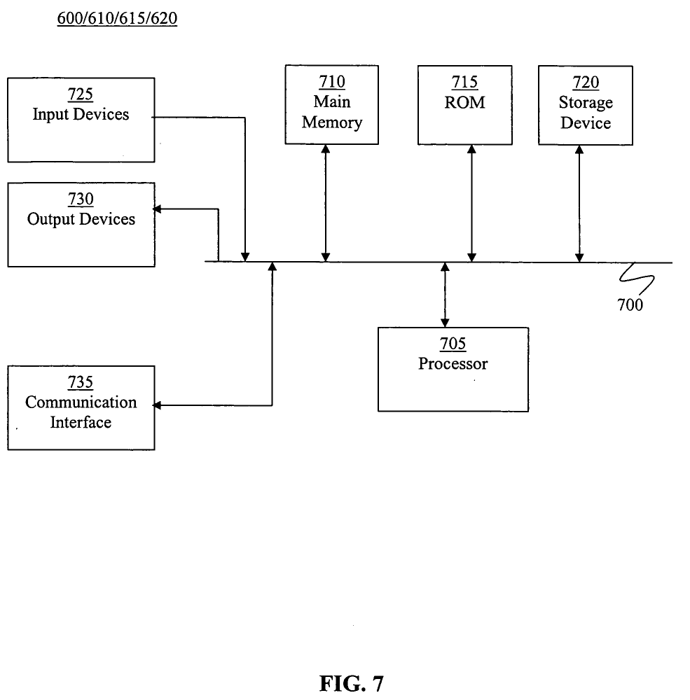

FIG. 7 is an exemplary diagram of a computing device 600, or of servers 610, 615, and 620. Computing device/servers 600/610/615/620 may include a bus 700, one or more processors 705, a main memory 710, a read-only memory (ROM) 715, a storage device 720, one or more input devices 725, one or more output devices 730, and a communication interface 735. Bus 700 may include one or more conductors that permit communication among the components of computing device/server 600/610/615/620.

Processor 705 may include any type of conventional processor, microprocessor, or processing logic that interprets and executes instructions. Main memory 710 may include a random-access memory (RAM) or another type of dynamic storage device that stores information and instructions for execution by processor 705. ROM 715 may include a conventional ROM device or another type of static storage device that stores static information and instructions for use by processor 705. Storage device 720 may include a magnetic and/or optical recording medium and its corresponding drive.

Input device(s) 725 may include one or more conventional mechanisms that permit a user to input information to computing device/server 600/610/615/620, such as a keyboard, a mouse, a pen, a stylus, handwriting recognition, voice recognition, biometric mechanisms, and the like. Output device(s) 730 may include one or more conventional mechanisms that output information to the user, including a display, a printer, a speaker, and the like. Communication interface 735 may include any transceiver-like mechanism that enables computing device/server 600/610/615/620 to communicate with other devices and/or systems. For example, communication interface 735 may include mechanisms for communicating with another device or system via a network, such as network F05.

As will be described in detail below, computing device 600 and/or servers 610, 615, and 620, may perform operations based on software instructions that may be read into memory 610 from another computer-readable medium, such as data storage device 720, or from another device via communication interface 635. The software instructions contained in memory 710 cause processor 705 to perform processes that will be described later. Alternatively, hardwired circuitry may be used in place of or in combination with software instructions to implement processes consistent with the present invention. Thus, various implementations are not limited to any specific combination of hardware circuitry and software.

A software application, such as a web browser, comprising a user interface may be used to display information (such as textual and graphical information) on the computing device 600. The software application may comprise any type of visual display capable of displaying information received via the network 605 shown in FIG. 6, such as Microsoft's Internet Explorer browser, Netscape's Navigator browser, Mozilla's Firefox browser, PalmSource's Web Browser, or any other browsing or other application software capable of communicating with network 605.

The software application may act as an intermediary between the user and the computing device 600 and/or the network 605. For example, source documents or other information received from devices connected to the network 605 may be output to the user via the software application. Also, the software application is capable of performing operations on received data prior to outputting data to the user. Further, the software application may receive user input and transmit the inputted data to servers 505/F15/F20 or other devices connected to the network 605.

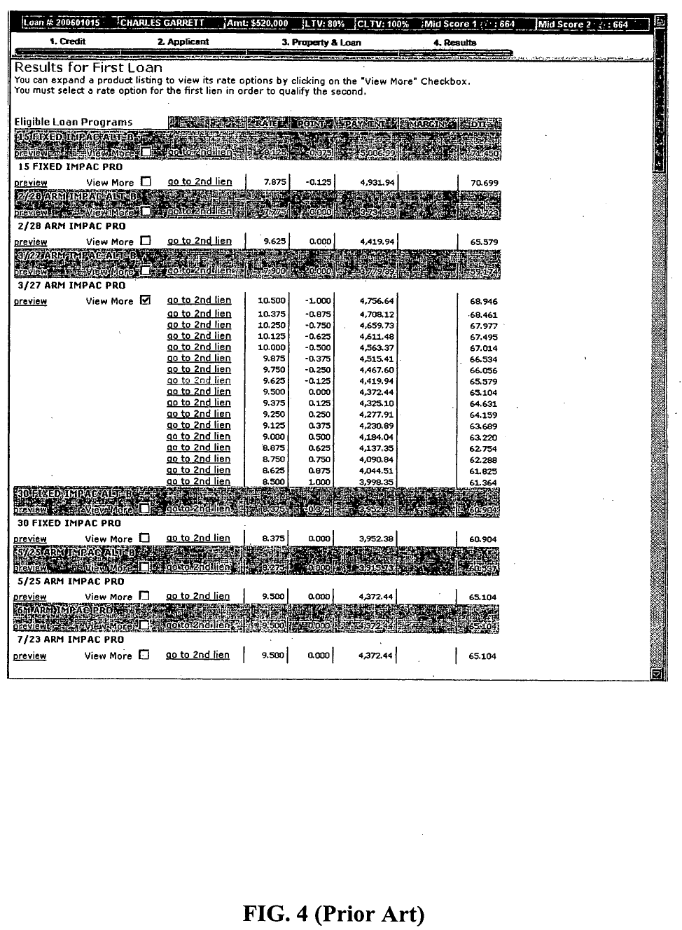

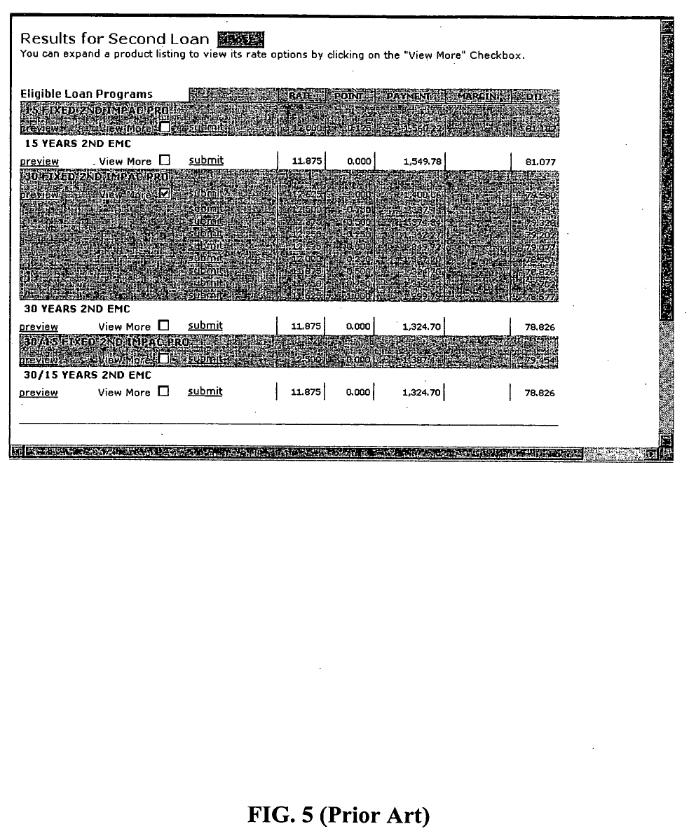

One exemplary embodiment of the present invention that may be used to overcome the limitations of the prior art is illustrated in FIG. 8. After the broker has selected potential first and second liens (such as shown in FIGS. 4 and 5), the mortgage service server 615 may take the calculated DTI for the second lien and the calculated DTI for the first lien and determine that it violates the maximum DTI condition for the first lien. The mortgage service server 615 may then notify the broker of the issue. For example, in FIG. 8, the broker is notified that the selected rate option for the first lien program has been adjusted due to the DTI from the combined payments from the selected first and second liens. In this example, the selected rate for the first lien program was 7.0 and the point was 0.625, however, due to the new DTI that takes into account the selected second lien mortgage payment, the mortgage service server 615 adjusts the first lien rate up to 8.0 with an associated point of 1.125. The broker is then asked if he would like to confirm this submission with the adjusted rate option.

While this method resolves the issue of calculating the new DTI based on the selected second lien program monthly payment, it still has limitations in that the broker must continue with the selected programs or start all over again by selecting a different first lien program and then a second lien program, and so on as described before.

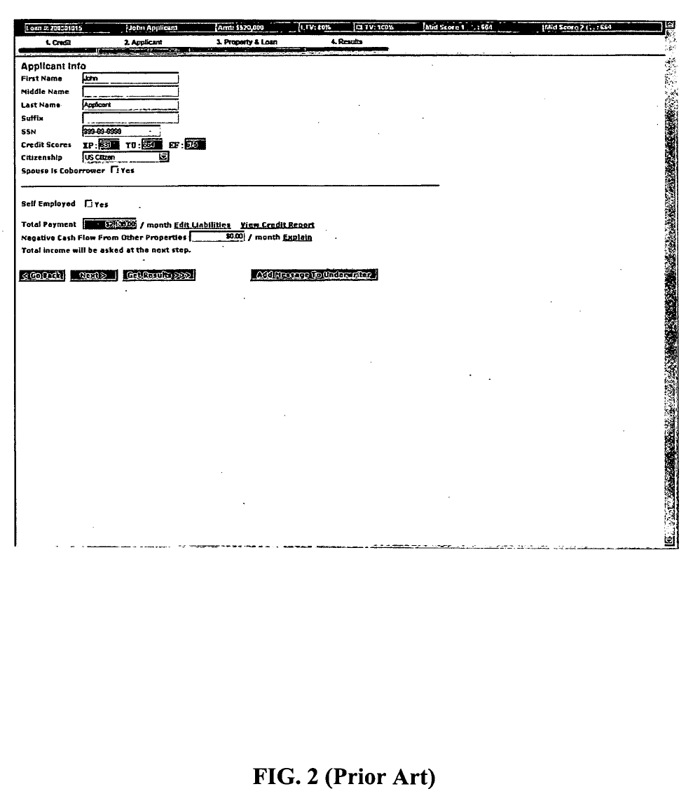

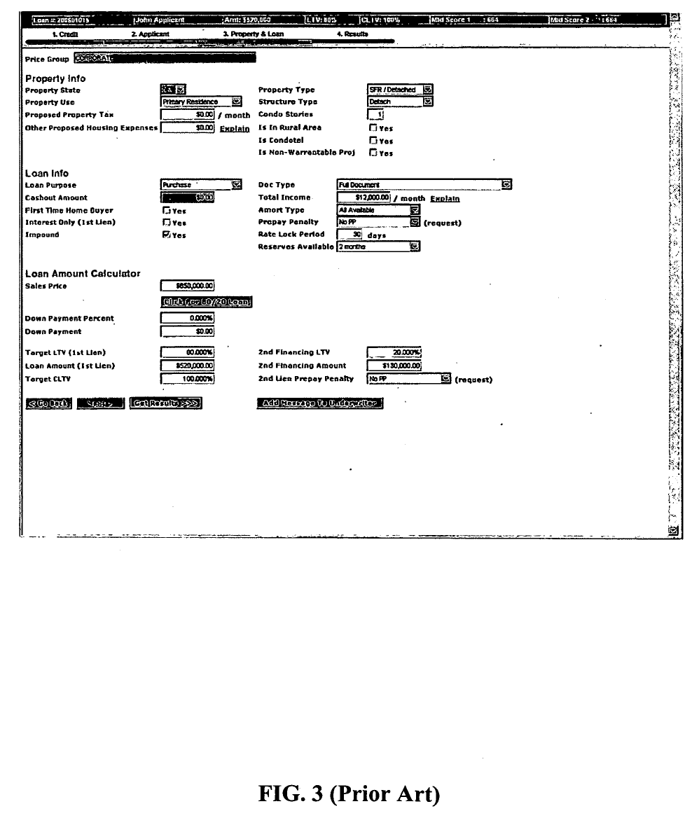

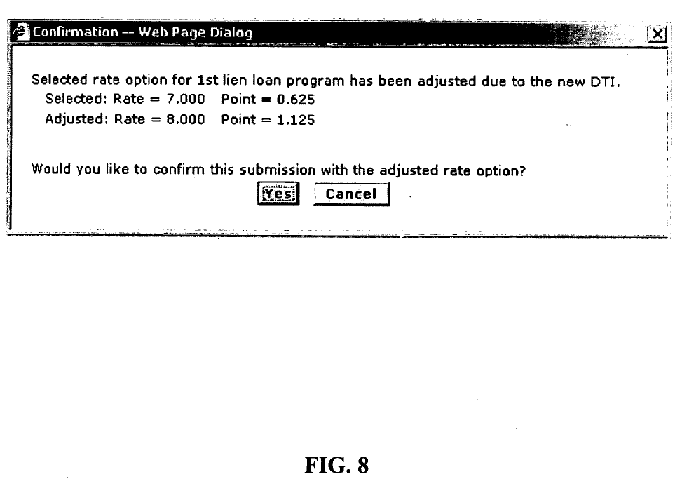

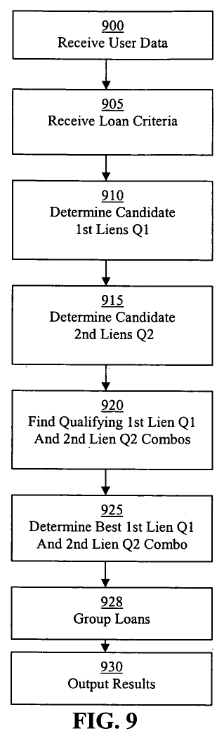

FIG. 9 illustrates an alternative method for improvement over the prior art. In FIG. 9, the mortgage service server 615 receives the user data similar to the user data illustrated in FIGS. 2 and 3. In block 905, the mortgage service server 615 receives loan criteria from the broker from the computing device 600. Such loan criteria may be, for example, the maximum interest rate that the applicant wants and/or the maximum payment that the applicant is willing to pay. Also, the loan criteria may include the minimum broker fee that the broker is willing to accept for his services in providing the loan to the applicant. Other loan criteria may be provided, such as desired term of loan, fixed rate, adjustable rate, interest-only, etc.

In block 910, the mortgage service server 615 determines the candidate first liens Q1. This determination is made by applying the applicant data and loan criteria to all potential first liens. The first liens may have been received, for example, from lender server1 610 and/or lender serverN 620 and/or other lender servers connected to 605 (not shown). Alternatively, mortgage service server 615 may contain a database with candidate first liens stored therein.

The rate and payments for each candidate first lien Q1 is calculated along with the associated DTI. This DTI is not the final DTI because it does not include the monthly payment that will be added once a second lien is selected with its associated monthly payment. Thus, the first lien DTI is stored for future use. Also, since the DTI will increase once the debt from the candidate second lien payment is factored in, DTI conditions for the first lien are also stored for later use. For example, the DTI with only the first lien factored in may be 45%, but the qualification requirements for the first lien program may stipulate that if the DTI were over 50%, another 0.5% must be added to the first lien interest rate. Therefore, this DTI requirement is stored so that, in the event that the second lien payment results in a DTI over 50%, the system can account for this DTI requirement.

Once the candidate first liens Q1 are determined, the mortgage service server 615 determines candidate second liens Q2 that are associated with the candidate first liens Q1 (block 915). This is done by applying the applicant information and the first lien Q1 information to the available second liens that may have been received from lender server1 610, lender servern 620, other lender servers connected to the mortgage service server 615 through the network 605 (not shown), and/or other second lien programs stored locally at the mortgage service server 615. Rate/payment information, DTI, and broker fee are then calculated for each rate for each candidate second lien Q2. DTI conditions for the candidate second liens Q2 may also be stored in a manner similar to that described for the first liens Q1.

In block 920, the mortgage service server 615 finds the qualifying combinations of the first liens Q1 determined in block 910 and the second liens Q2 determined in block 915. This is done by calculating the payment and broker fee associated with each rate for each candidate first lien, adding them to the calculated payment and broker fee associated with each rate for each candidate second lien. Once this is done, the mortgage service server 615 checks the new DTI for the combined payments against any DTI conditions that were previously stored for the first lien. If any stored DTI conditions are now violated, any penalties (such as a higher rate and payment) are factored in and the new payment/fee is calculated. The mortgage service server 615 may also verify that any DTI conditions for the candidate second liens are not violated. Optionally, one or more iterations of this checking process may occur until no violations of the DTI conditions of the candidate first and/or second liens are found.

For each first and second lien combination, the mortgage service server 615 determines if the combined payment is less than the maximum payment inputted by the broker and if the combined broker fee is more than the minimum broker fee inputted by the broker. If so, the combination of the rate from the candidate first lien and the rate from the candidate second lien is determined to be a qualifying combination that is available for the loan applicant. Any such qualifying combinations are stored. If the combined payment exceeds the maximum payment inputted by the broker or the combined broker fee is less than the minimum broker fee inputted by the broker, a qualifying combination is not found. Each combination of the rates for the candidate first and second lien may be checked until finished.

Optionally, in block 925, the mortgage service server 615 may also determine the best first lien Q1 and second lien Q2 combination based on the inputted loan criteria. For example, the best combination of candidate first lien Q1 and second lien Q2 may be a qualifying combination that provides the lowest interest rate and/or payment for the applicant and the highest broker fee. Alternatively, the best combination may be the combination with the lowest combined payment and a broker fee that exceeds the minimum provided by the broker. As will be recognized by those of ordinary skill in the art, other criteria may be provided for determining the optimal combination.

In block 928, the mortgage service server 615 groups the loans by common characteristics. For example, the mortgage service server 615 may group the first liens based on common length of loan and interest rate terms, i.e., the 30 year fixed interest rate loans may be grouped together, the 30 year adjustable rate mortgages that are fixed for 3 years may be grouped together and so on.

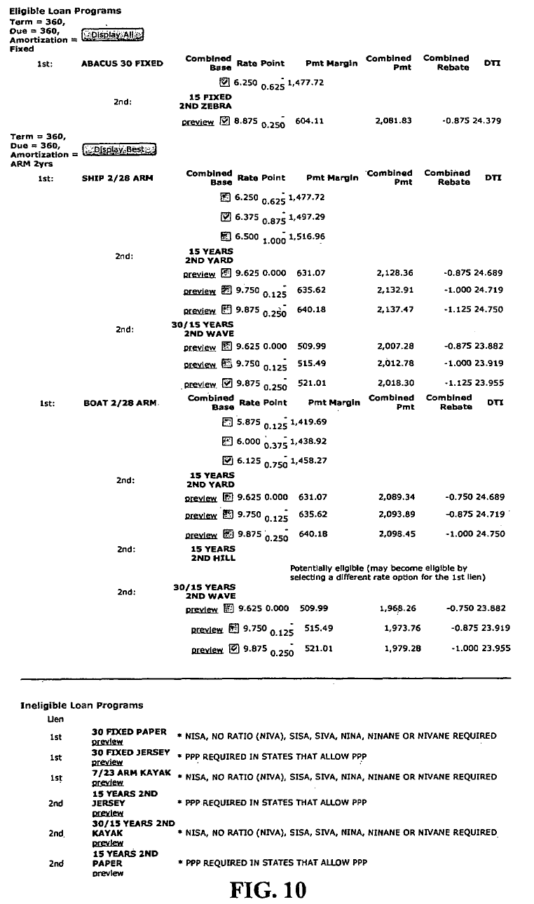

In block 930, the mortgage service server 615 outputs the results of the determination to computing device 600 through network 605. An example of the output is illustrated in FIG. 10. Here, the mortgage service server 615 found three potential first liens associated with the applicant data and the loan criteria that was received from the computer device 600. In this example, the three qualifying first liens are the ABACUS 30 FIXED, the SHIP 2/28 ARM and the BOAT 2/28 ARM. With each first lien, the mortgage service server 615 also outputs the associated second liens. For example, the associated second lien for the ABACUS 30 FIXED is the 15 FIXED 2ND ZEBRA. As shown, there are also second liens associated with the SHIP 2/28 ARM and the BOAT 2/28 ARM.

In the example shown in FIG. 10, the loans are grouped together based on common loan terms. For example, of the eligible loan programs, the ABACUS 30 FIXED is the only qualifying first lien in the first category (30 year fixed). The second category is the 30 year loan with a 2 year adjustable rate mortgage. The two qualifying liens in this category are the SHIP 2/28 ARM and the BOAT 2/28 ARM. In this example, the user has selected to display all of the results for the 30 year, 2 year fixed adjustable rate mortgage. Accordingly, the two associated second liens are shown for the SHIP 2/28 ARM and three associated second liens are shown with the BOAT 2/28 ARM. As shown in FIG. 10, the best rate and fee pair as determined in step 925 is shown by checkmarks in the boxes. For example, the best rate/fee pair for the SHIP 2/28 ARM has a first-lien rate of 6.375%, a point of 0.875, and a payment of $1,497.29, with the best second lien option being the 30/15 YEARS 2ND WAVE with an associated rate of 9.875%, a point of 0.250, and a payment of $521.01. This combination results in a combined payment of $2,018.30, combined DTI of 23.955%, and a combined rebate to the broker of 1.125 points.

The broker is also able to see the best combination for the BOAT 2/28 ARM. Here, in this example, the best first lien rate is 6.125%, the point is 0.750, and the payment is $1,458.27. The best second lien is the 30/15 YRS 2ND WAVE with an associated rate of 9.875%, point of 0.250 and a payment of $521.01. This results in a combined payment of $1,939.28, a combined rebate of 1 point, and combined DTI of 23.955%.

In this manner, the mortgage service server 615 is able to provide an output to the broker that groups the qualifying loan programs together by common factors all in one output, which greatly reduces the amount of time required by the broker to shop for different loan programs. Also, the broker is able to immediately see the best first lien program and associated second lien program, while all of the qualifications for the DTI for the first lien are taken care ahead of time. All of this information is provided in one output to the broker. As shown in FIG. 10, if the broker selects a different rate by clicking on the 6.00% rate for the BOAT 2/28 ARM, the mortgage service server 615 will then recalculate which is the best second lien associated with that rate by determining the combined payment closest to the maximum payment allowed by the applicant and the lowest combined fee payable to the broker.

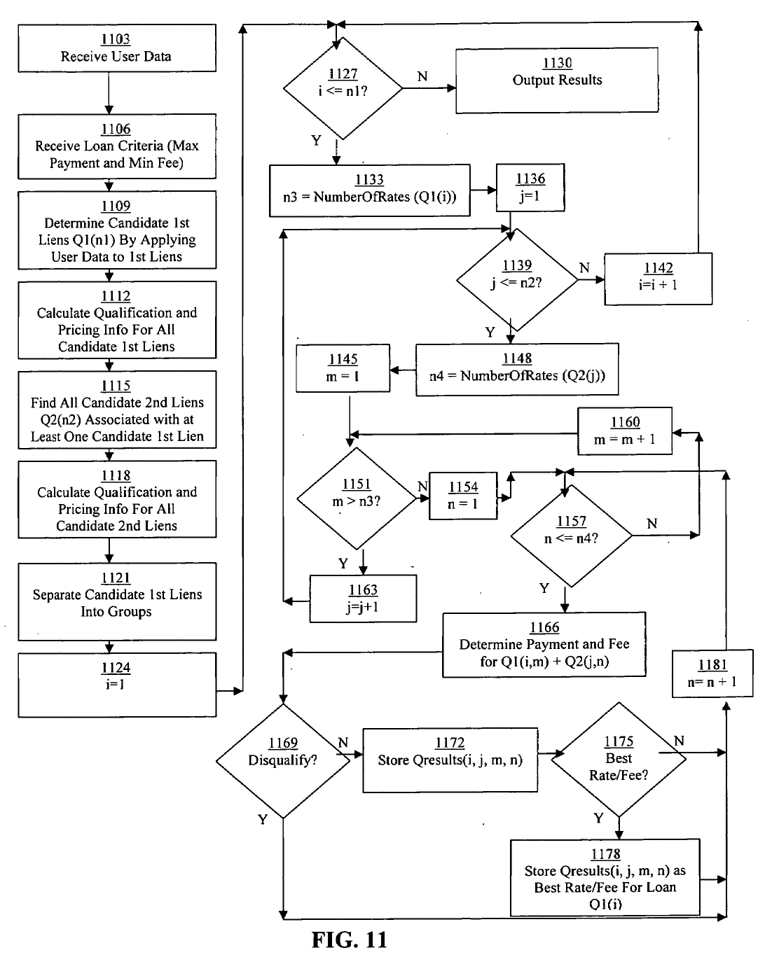

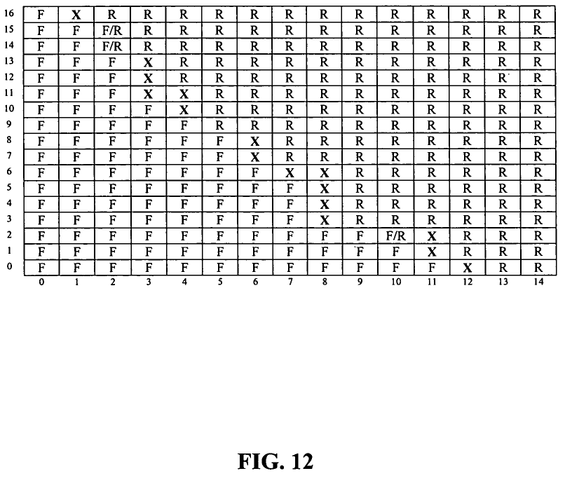

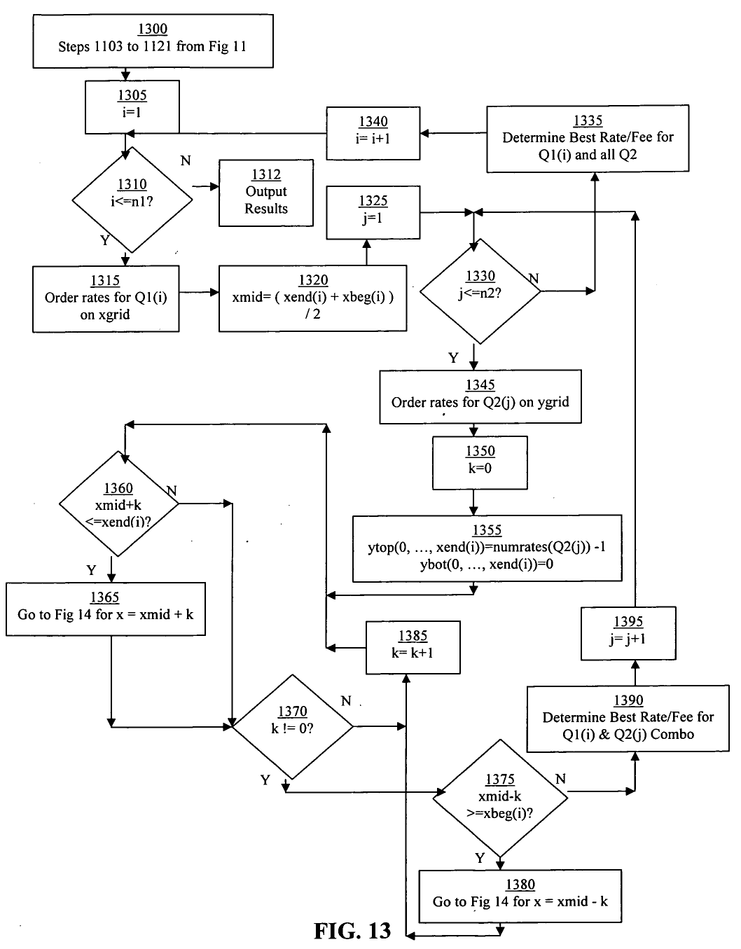

FIG. 11 illustrates an exemplary embodiment for use in determining the qualifying first and second liens and determining the best rate and fee combinations for those liens. In block 1103, the mortgage service server 615 receives user data as described before. In block 1106, the mortgage service server 615 receives loan criteria such as the maximum payment or rate by the applicant, and a minimum amount of fee payable to the broker as described before. In step 1109, the mortgage service server 615 determines the candidate first liens Q1(n1) by applying the received user data to the first liens as discussed previously. In block 1112, the mortgage service server 615 calculates the qualification and pricing information for all of the candidate first liens.

This determination generally results in the potential interest rates, payments, broker fees and the associated DTI, as discussed above. Once the applicant data is applied to the candidate first liens Q1, the payment associated with the first lien is calculated. The mortgage service server 615 will store other qualification information that may come into effect once the payment from the second lien is factored in. For example, if the first lien payment results in a DTI of 55.4 with the applicant's monthly debt payment and the first lien payment factored in, the first lien may still have a requirement that, if the DTI is over 60, another percentage point must be added on to the interest rate. This information will be stored by the mortgage service server 615 for later use once the DTI for the combined first lien and second lien payments is calculated.

In block 1115, the mortgage service server 615 finds all candidate second liens Q2(n2) that are associated in at least one candidate first lien. In block 1118, the mortgage service server 615 calculates the qualification and pricing information for all the candidate second liens similar to that performed in block 1112 for all candidate first liens. In block 1121, the mortgage service server 615 separates the candidate first liens into groups based on common factors, such as, for example, by including all 30 year fixed loans together, all the 30 year, 3 year fixed adjustable rate mortgages together, etc.

In block 1124, a counter i is set to 1. This counter relates to the first lien Q1 that is being evaluated by the mortgage service server 615.

In block 1127, it is determined whether the counter i is less than or equal to the number of first liens in Q1. If i≦n1, in block 1133 the variable n3 is set to the number of rates that are associated with the first lien Q1(i). Then in block 1136, counter j=1 is set. Counter j is associated with the second lien Q2 that is being evaluated. In block 1139, it is determined whether the counter j≦n2, the number of second liens. If j≦n2, then, in block 1148, the variable n4 is set to the number of rates that are in Q2(j).

In block 1145, a counter m is set to 1. The counter m relates to the rate associated with the first lien Q1(i) that is being evaluated. In block 1151, if the counter m is greater than n3, which is the number of rates in Q1(i), all of the rates in Q1(i) have been evaluated. In 1163, the counter j is incremented to go on to the next second lien in Q2(j).

If m is less than or equal to n3 in block 1151, then in block 1154, a counter n is set to 1. In block 1157, it is determined whether n is less or equal to n4, the number of rates in Q2(j). If n is greater than n4, you have evaluated all the rates for second lien Q2(j), and thus, in block 1160, the counter m is incremented by 1 to move on to the next rate associated with the first lien Q1(i). If the rates of second lien of Q2(j) are not finished being evaluated, in block 1166, the mortgage service server F15 determines the payment and broker fee for Q1(i, m) in combination with the second lien in Q2(j, n). In this block, if the combined DTI exceeds any stored DTI conditions of the first and/or second liens, the payment is adjusted based on the conditions as described above.

In block 1169, the mortgage service server 615 determines whether the payment and fee for the combined first and second liens will qualify. In this block, the mortgage service server 615 evaluates the combined rate/payment and broker fee for both the first and second liens. If the combined payment is less than the inputted maximum amount, and the combined broker fee is more than the minimum amount, the first and second lien combination qualifies. If so, in block 1172, the mortgage service server 615 stores the results in an array Qresult(i, j, m, n). Qresult keeps track of the first and second liens, with their associated rates, that meet the qualification requirements.

In block 1175, the mortgage service server 615 determines if the Qresult(i, j, m, n) is the best rate and fee combination. If so, in block 1178, that combination is stored as the best rate and fee for the loan Q1(i).

After blocks 1169, 1178, or 1175, the counter n is incremented by 1 (block 1181) and it is determined in block 1157 if the system is done evaluating the rates for the second liens. If so, in block 1160, the next rate for the first lien is evaluated. If the rates for the first lien Q1(i) are finished being evaluated, then, in block 1163, the counter j is incremented to evaluate the next second lien in Q2(j). In block 1139, if it is determined that all of the second liens in Q2(j) have been evaluated, then the counter i is incremented in block 1142 to evaluate the next first lien Q1(i).

In block 1127, if the counter i is greater than the number of first liens, all of the first liens Q1 have been evaluated along with all of the corresponding second liens Q2 and their associated rates. If so, then in block 1130, the mortgage service server 615 outputs the results to the computer device 600 through the network 605.

An example of the results as shown in FIG. 10 was described before. In this manner, all of the qualifying Q1 and Q2 liens, as well as the best rate and fee pairs, are output to the user so that the broker is not required to determine whether a selected second lien violates the DTI requirements from the associate first lien. Also, the first liens are grouped by common characteristics for ease of use. As will be recognized by those of ordinary skill in the art, modifications may be made to the preceding exemplary embodiment. For instance, certain steps may be performed in different orders or may not be performed at all without deviating from the spirit and scope of the invention.

In another embodiment, an optimization of the searching algorithm for determining the first and second lien pairs that qualify may be utilized. As shown in FIG. 12, an exemplary first lien with its associated rates, information, and fees may be organized in terms of an array starting with the lowest rate being shown at column 0 and the highest rate being shown on column 14 on the x-axis on the table. An associated second lien can be organized in terms of an array with the lowest rate being at row 0 and the highest rate being located at row 16, such as shown on the table illustrated in FIG. 12.

In common practice, the highest rate associated with a loan is also associated with the lowest fee payable to the broker, and vice-versa. Thus, column 0 and row 0 represent the first and second lien combination where the lowest possible broker fee occurs. As you move to the right or up in the table, the broker fee increases, but the combined fee may still be lower than the minimum provided by the broker. Accordingly, the Fs illustrated in the table represent where the combination of the first and second lien results in the broker fee being below the minimum fee specified by the broker. Similarly, in this example, the highest rate/payment occurs at column 14 and row 16. As you move to the left or down from this column, the combined payment decreases. Thus, the Rs illustrated in FIG. 12 represent the situation where the combined rate/payment for the first and second liens result in a rate/payment that is above the maximum rate/payment provided by the applicant. The Xs illustrated in FIG. 12 represent the situation where the combined rate/payment and broker fee for the first and second liens result in a combined rate/payment that is below the maximum provided by the applicant and a combined broker fee that is above the minimum provided by the broker.

To further illustrate this point, column 6 represents one rate and fee for the first lien and row 7 represents one rate and fee for an associated second lien. The combination of the sixth rate for the first lien and the seventh rate for the second lien results in a qualifying combination, which is represented by the X in this example. If the rate is decreased for the second lien (as shown in row 6), this results in the fee being below what the broker previously specified. If the rate for the second lien is increased (as shown in row 8), that combination also results in a qualifying combination. If the rate for the second lien is increased up to row 9, the combined rate and payment exceeds the amount specified by the user and is not qualifying (illustrated by the R).

Similarly, if the rate for the first lien is increased to column 7, and the rate for the second lien is maintained at row 7, this combination results in a rate and payment that exceeds the amount specified by the applicant (illustrated by the R). If the rate is decreased from the sixth column to the fifth column, then the broker fee is below the minimum broker fee specified by broker, resulting in a disqualifying combination (as illustrated by the F).

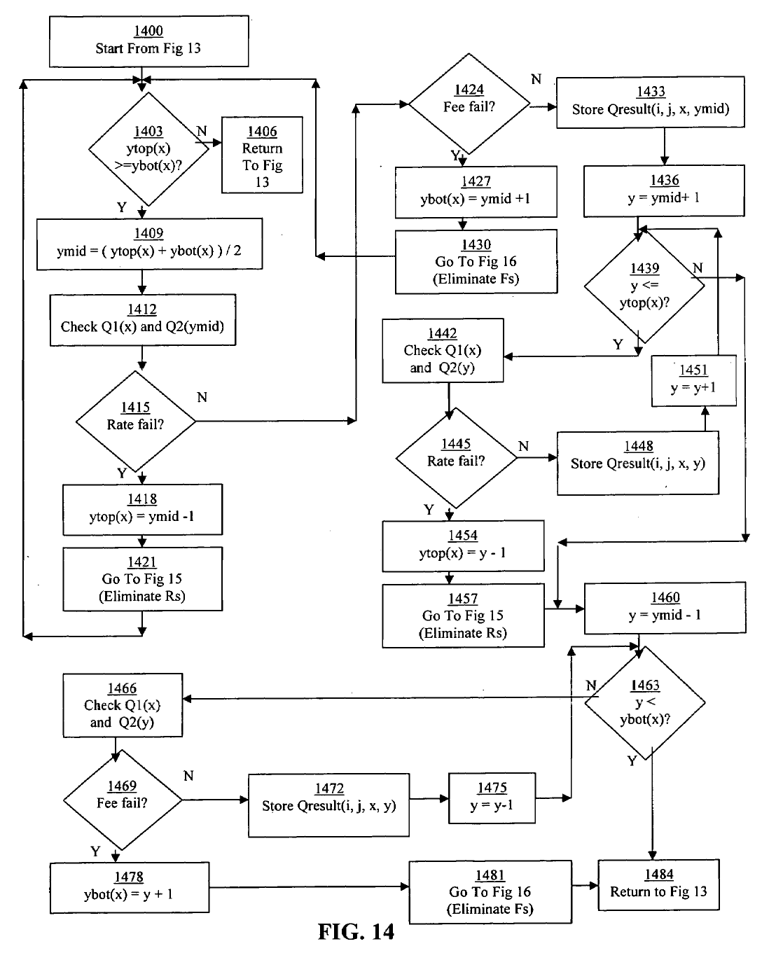

As described in the preceding example, distributing the associated rates for a first and second lien on a grid similar to that shown in the example in FIG. 12 results in potential optimizations in determining the qualifying first and second liens, and the best combination. An exemplary embodiment of this method is illustrated in FIGS. 13-16.

Specifically, in block 1300 of FIG. 13, block 1103 to 1121 for FIG. 11 are performed as previously described. In block 1305, a counter i is set to 1. In block 1310, it is determined whether counter i is less than or equal to the number of first liens Q1. If counter i, which represents which first lien is presently being evaluated, exceeds the number of first liens Q1, in block 1312 the results are output to the user similar to that shown in the example in FIG. 10. If counter i is less than the number of first liens, in block 1315, the rates associated with first liens Q1(i) are ordered on the x-axis of the grid as previously discussed for FIG. 12. In the example shown in FIG. 12, there are 15 associated rates with first lien Q1(i) and they are ordered on the grid from 0 to 14.

In block 1320, the variable xmid is calculated as being (xend(i)+xbeg(i))÷2. The value xend(i) is equal to the position of the final rate available for the associated first lien in Q1(i). In this example, xend(i) is equal to 14, as shown in FIG. 12. The value xbeg(i) is equal to the position of the first rate associated with the first lien in Q1(i), which is 0 (as shown in FIG. 12).

In 1325, a counter j is set to 1. The counter j is used for determining which second lien in Q2 is being evaluated. In block 1330, it is determined whether the counter j≦n2 where n2 is the number of first liens. If j is greater than the number of first liens, all of first and second liens have been evaluated. If j≦n2, in block 1345 the rates for the second lien Q2(j) are ordered on the y-axis of the grid, as shown for example in FIG. 12. In this example, the are seventeen rates associated with second lien Q2(j) and they are ordered from starting at the lowest rate at row 0 to the highest rate at row 16.

In block 1350, another counter k is set to 0. In block 1355, an array ytop (0, . . . , xend(i)) equals the number of rates that are associated with the second lien in Q2(j) minus 1. In this example, ytop(0 to 14) would be equal to 17−1=16. ybot (0, . . . , xend(i)) is set to 0. ytop represents the top box on the grid that has not been evaluated in terms of determining whether that box is a qualifying combination or not. Similarly, ybot represents the bottom box of each column that has not been evaluated by the mortgage service server 615. The index to the arrays ytop and ybot is based on the column, thus, for example, ytop(column 5) is 16 and ybot(column 5) is 0.

In Box 1360, it is determined whether xmid+k≦xend(i). In this block, it is determined whether the mortgage service server 615 has reached the end column in FIG. 12 meaning that all of the first and second lien programs to the right have been evaluated. If xmid+k≦xend(i), then in block 1365, FIG. 14 is evaluated for x=xmid+k. In the current example, xmid is equal to (14+0)÷2=7. In FIG. 14, column x=7 will be evaluated to determine any qualifying first and second lien combinations for Q1(i) and Q2(j).

In block 1400 of FIG. 14, the mortgage service server 615 proceeds from first block 1400 to block 1403 to determine whether ytop(x) is greater than or equal to ybot(x). If ytop(x) is less than ybot(x), the column is finished being evaluated, and in block 1406, the mortgage service server 615 returns to the appropriate box in FIG. 13.

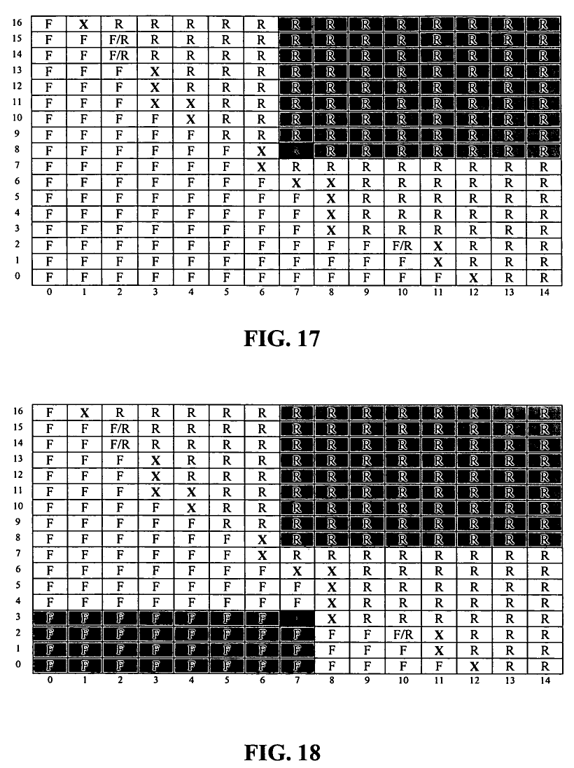

If ytop(x) is greater or equal to ybot(x), the column is not finished being evaluated and the mortgage service server 615 proceeds to block 1409. Here a variable ymid is set to (ytop(x)+ybot(x))÷2. Thus ymid is set to the row where the combination of first and second liens Q1(i) and Q2(j) will be evaluated. In this example, ymid=(16+0)÷2=8, thus, as shown in FIG. 17, column 7 and row 8 will be evaluated.

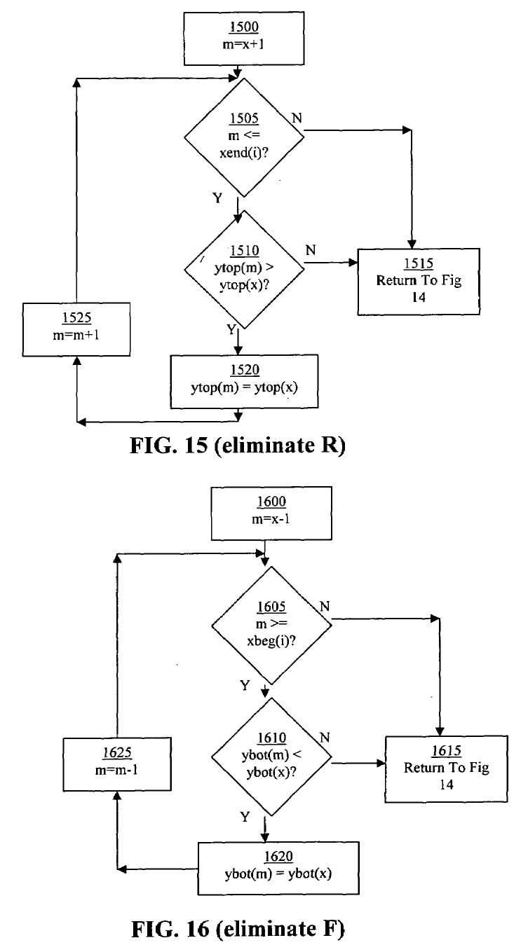

In block 1412, the mortgage service server 615 checks whether Q1(x) and Q2(ymid) is a qualifying combination, as described previously. In this example, column 7 and row 8 results in a rate/payment above that specified as a maximum by the applicant. In block 1415, the mortgage service server 615 determines that the rate failed and proceeds to block 1418 where ytop(x) is set to ymid-1. In this example, ytop(7) is set to 8−1=7. This is so because if the rate is increased for the second lien, such as to column 9, by default that rate and payment will be higher than the rate/payment associated with row 8. Therefore, there is no need to evaluate the rest of the rates/fees for the first and second lien combinations from column 8 to column 16. Similarly, in block 1421, the rates in row 8 that are to the right of column 7 also do not need to be evaluated. This is so because, if the rate for the first lien Q1(7) is increased, the rate/payment will be higher than the rate/payment in column 7, which has already resulted in a rate/payment that exceeds the maximum rate and payment specified by the applicant. Thus in block 1421, the mortgage service server 615 proceeds to FIG. 15 to eliminate the Rs to the right and above of column 7 and row 8.

As shown in FIG. 16, in block 1500, the counter m is set to x+1, which in this example would be set to 7+1=8. In block 1505, the mortgage service server 615 determines whether m≦xend(i). If it is, in block 1515 the mortgage service server 615 returns to FIG. 14. If it is not, in block 1510, the mortgage service server 615 determines if ytop(m) is greater than ytop(x). This determines whether the topmost value of the next column that has not been evaluated is greater than the topmost value of the column that has now been determined to be disqualified under the rate limitations. If the top of the next column is greater than the top of the column under evaluation, then in block 1520, the ytop of the next column is set equal to the top of the column being evaluated. In this example, ytop(8) was equal to 16, so ytop(8) is set to ytop(7)=7.

In block 1525, the counter m is incremented and the process repeated. As shown in this example, in FIG. 17, the gray area illustrates the boxes where the column and row do not need to be evaluated because it is already known that these boxes would violate the rate and payment limitation. Thus ytop of columns 7 through 14 is set to 7 because row 7 has not been evaluated yet for columns 7 through 14. Once column 14 has been evaluated, in block 1505, m would be greater than xend(i) and, in block 1515, would return to block 1421 of FIG. 14.

The mortgage service server 615 then returns to block 1403 and determines whether ytop(x) is greater or equal to ybot(x). In the present example, ytop(7) is now equal to 7 and ybot(7) is equal to 0, thus the mortgage service server 615 proceeds to block 1409. Now ymid will equal (7+0)÷2=3 (the integer result of the calculation).

In block 1412, the mortgage service server 615 checks Q1(7) and Q2(3), which is shown as the dark highlighted box in column 7 and row 3 of FIG. 18. In block 615, it is determined that the rate does not fail in this block, and in block 1424, it is determined that the fee did fail. The mortgage service server F15 then proceeds to block 1427.

In block 1427, ybot(x=7) is set to ymid+1=3+1=4. This is so because if the next lowest row is evaluated, such as row 2, this fee will go down and be less than the fee that was already determined to be too low. Thus, all of the rows below row 3 will also result in a fee violation. In block 1430, the mortgage service server 615 will go to FIG. 16 to eliminate the other Fs to the left of column 7 because moving to the left also results in a fee that is lower than the one that was already determined to be too low.

In block 1600 of FIG. 16, a counter m is set to x−1 to evaluate the column to the left of x=7. In block 1605, it is determined if m>xbeg(i) and, if it is, in block 1615 the mortgage service server 615 returns to FIG. 14. In this example, m would be equal to 6 and xbeg(i)=0, thus the mortgage service server 615 will proceed to block 1610.

In block 1610, it is determined whether ybot(m) is less than ybot(x). If so, then all of the entries in the column have been evaluated already and thus the mortgage service server 615 will return to FIG. 14 in block 1615. In this example, ybot(column 6) is 0 and is less than ybot(column 7), which is equal to 4. Thus in block 1620, ybot of column 6 is set to ybot(column 7)=4. The counter m is then decreased by 1 (block 1625) to look at the next left column and the process continues until all of the columns to the left of column 7 are set so that ybot of that column is equal to ybot(column 7) (as shown in the example in FIG. 18). Thus, it is known that rows 0 to row 3 would result in a fee violation, ybot from column 0 to column 7 is set to 4, which is equal to the row that has not evaluated. Once ybot has been set to appropriate row, then the mortgage service server 615 returns to FIG. 14 in block 1615, which results in returning to block 1430 of FIG. 14.

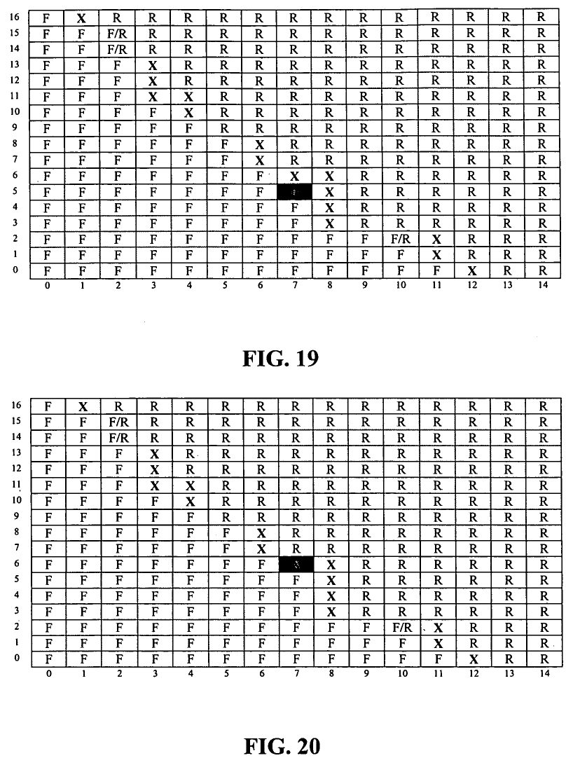

The mortgage service server 615 proceeds to block 1403 and determines if ytop(7)≧ybot(7). In this case, ytop(7) is now equal to 7 and ybot(7) is equal to 4, thus ytop(7) is greater than ybot(7), and the mortgage service server 615 proceeds to block 1409. The value ymid is set to (ytop(7)+ybot(7))÷2 is equal to (7+4)÷2=11÷2=5. Thus, the next box being evaluated, as shown in FIG. 19, is column 7 and row 5 (as shown by the dark highlighted box).

In block 1412, Q1(7) and Q2(5) is evaluated. In block 1415, it is determined that the rate did not fail, but then in block 1424, it is determined that the fee did fail. Thus, in block 1427, ybot(7)=ymid+1=4+1=5. In block 1430, the mortgage service server 615 proceeds to FIG. 16 to eliminate the Fs to the left of column 7 as shown in FIG. 19. Thus, ybot for columns 0 through 7 is now set to 6.

The mortgage service server 615 proceeds to block 1403. In block 1403, ytop(x) is equal to 7 and ybot(x) is now equal to 6, and thus, in block 1409, ymid is set to (7+6)÷2=6.

In block 1412, the mortgage service server 615 checks Q1(7) and Q2(6), which is shown in the example of FIG. 20 by the darkened box. Here in block 1415 the rate does not fail, and in block 1424 the fee does not fail. Thus, in block 1433, the mortgage service server 615 stores the Qresult(i, j, x, ymid). This is done because if the rate and fees did not fail in blocks 1415 and 1424, then the result has to be a qualifying result (as shown in FIG. 20).

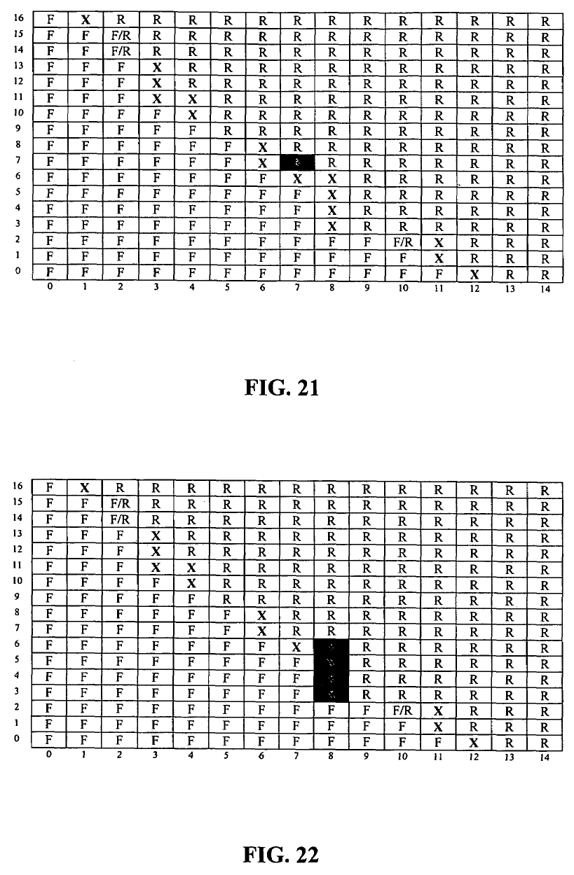

In block 1436, a new variable y is set to ymid+1 to evaluate the rows above the qualifying row currently being evaluated. In block 1439, it is determined whether y≦ytop(x). In this situation, y is equal to 6+1=7, and ytop(7) is equal to 7. Thus the mortgage service server 615 proceeds to block 1442 and checks Q1(x) and Q2(y), which as shown in FIG. 21, results in a rate that violates the maximum rate and payment allowed. Thus in block 45, it is determined that the rate failed. In block 1454, ytop of column 7 is set to y−1=7−1=6. In block 1457, the mortgage service server 615 goes to FIG. 16 to eliminate the Rs in row 7 from columns 8 to column 14 as discussed previously.

In block 1460, the variable y is set to ymid−1=6−1=5 to evaluate the rows below the row that was found to qualify. In block 1463, it is determined whether y is less than ybot(x). In this example, y=5, therefore it is less than ybot(7)=6. Thus in block 1484, the mortgage service server 615 returns to FIG. 13 because the entire column 7 has now been evaluated (as shown in the example in FIG. 21).

Now returning FIG. 13, the mortgage service server 615 proceeds from block 1365 to block 1370 and determines whether k is equal to 0. In this example k is equal to 0 and thus, the mortgage service server 615 proceeds to block 1385 and increments k to k=k+1=1. In block 1360, it is now determined that xmid+k=8≦xend(i)=14. In block 1365, the mortgage service server 615 goes to FIG. 14 to evaluate column 8, i.e., x=xmid+k=7+1=8.

In block 1403 in FIG. 14, ytop(x) is compared to ybot(x), which in this example ytop(8) is equal to 7 and ybot(8) is equal to 0, thus the mortgage service server 615 proceeds to block 1409 and ymid is set to (ytop(8)+ybot(8))÷2=(6+0)÷2=3.

In block 1412, the mortgage service server 615 checks Q1(8) and Q2(3), and as shown in FIG. 22, column 8 and row 3 is a qualifying result. Thus the mortgage service server 615 proceeds to block 1433 and stores the Qresult(i, j, x, ymid). Then in block 1436, the variable y is set to ymid+1=3+1=4, which in this example will look for other qualifying combinations in the rows above row 3. In block 1439, it is determined whether y≦ytop(8) and, in this example, 3 is less than 6, thus the mortgage service server 615 proceeds to block 1442 and checks Q1(8) and Q2(4).

As shown in the FIG. 22, Q1(8) and Q2(4) is a qualifying combination. Thus, in block 1445, the rate does not fail and the mortgage service server 615 proceeds to block 1448 and stores Qresult(i, j, x, y). In block 1451, a counter y is incremented by 1 to proceed to the next row above the current row.

The mortgage service server 615 will proceed back through blocks 1439, 1442, 1445 and 1448 to store the result in column 8 and rows 5 and 6 as shown in FIG. 22. Once the counter y is set to 7, then in block 1439 the mortgage service server 615 proceeds down to block 1460 and y is set to ymid−1−3=1=2. In block 1463, y=2 is greater than xbot(x)=0, thus the mortgage service server 615 proceeds to block 1466 and checks Q1(8) and Q2(2). In this example, in block 1469, it is determined that the fee fails for column 8 and row 2, thus in block 1478, ybot(8) is set to 2+1=3 (see FIG. 23). In block 1481 the mortgage service server 615 proceeds to FIG. 16 to eliminate the other fee results to the left, which in this example has already occurred, thus in block 1610 of FIG. 16, ybot of the column to the left would not be less than the ybot of the current column. Thus, the mortgage service server 615 returns to block 1481 in FIG. 14, and then in block 1484, returns to FIG. 13 because column 8 has been fully evaluated.

In returning to FIG. 13, in block 1370, the mortgage service server 615 determines that k does not equal 0 and proceeds to block 1375, where it is determined whether xmid-k≧ybeg(i). In this example xmid-k=7−1=6>0, thus the mortgage service server 615 proceeds to block 1380 and goes to FIG. 14 for column 6, i.e., x=xmid-k=7−1=6.

Column 6 is now evaluated to find qualifying rate and fee pairs. In block 1403, it is determined that ytop(6)=16 is greater than or equal to ybot(6)=6. In block 1409, ymid is set to (ytop(6)+ybot(6))÷2=(16+6)÷2=11.

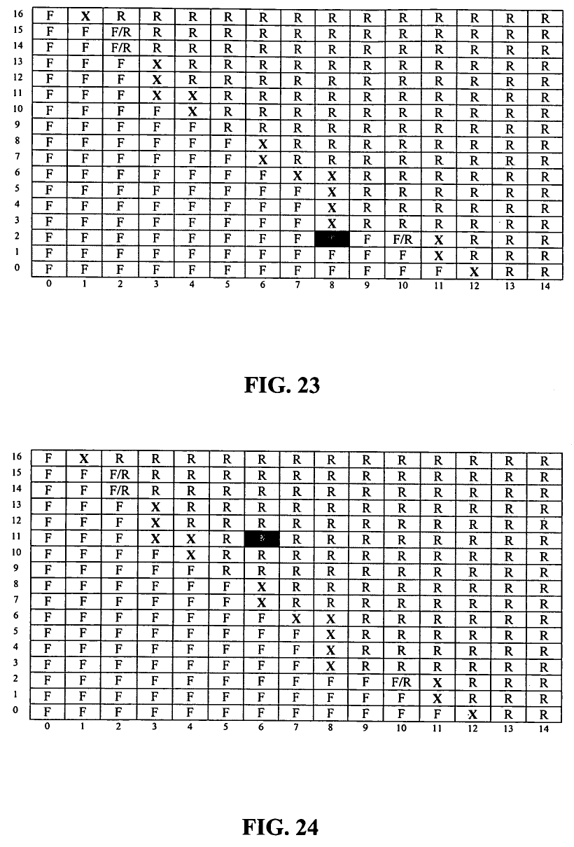

In block 1412, the mortgage service server 615 checks Q1(6) and Q2(11) and, as shown in the example in FIG. 24, column 6 and row 11 are evaluated. As shown, this combination violates the maximum rate and payment provided by the applicant. Thus, in block 1415, it is determined that the rate fails and, in block 1418, ytop(6) is set to ymid−1=11−1=10. In block 1421, the mortgage service server 615 goes to FIG. 15 and eliminates the boxes above row 11 and column 6, and the others to the right of column 6 as described previously.

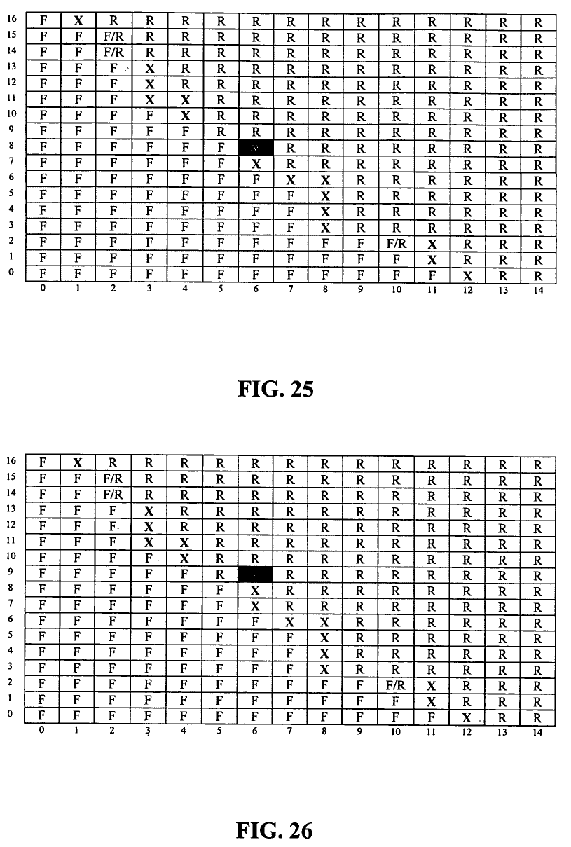

In block 1403, it is determined that ytop(6) is still greater than ybot(6). In block 1409, ymid is set to (10+6)÷2=16÷2=8. In block 1412, the mortgage service server 615 checks Q1(6) and Q2(8) as shown in the darkened box in FIG. 25 in column 6, row 8. This combination results in a first and second lien that qualifies, thus the mortgage service server 615 proceeds from block 1415 to block 1424 to block 1433 to store Qresult(1, 1, 6, 8).

The mortgage service server 615 proceeds to block 1436 and sets a variable y to ymid+1=8+1=9, and in block 1439 determines that 9≦ytop(6)=10. In block 1442, the mortgage service server 615 checks Q1(6) and Q2(9) as shown in the gray box in FIG. 26. In this situation, in block 1445, the mortgage service server 615 determines that column 6 and row 9 exceeds the maximum rate provided by the applicant and proceeds to block 1454 where ytop(6)=y−1=9−1=8. In block 1457, the mortgage service server 615 proceeds to FIG. 15 to eliminate the other boxes above row 9 as shown in FIG. 26.

In block 1460, y is set to ymid−1=8−1=7. In block 1463, it is determined that y is greater than ybot(6), thus in FIG. 27, column 6 and row 7 is evaluated in block 1466. As shown, this first lien and second lien combination is a qualifying combination, and the combination is stored in block 1472 as Qresult(1, 1, 6, 7).

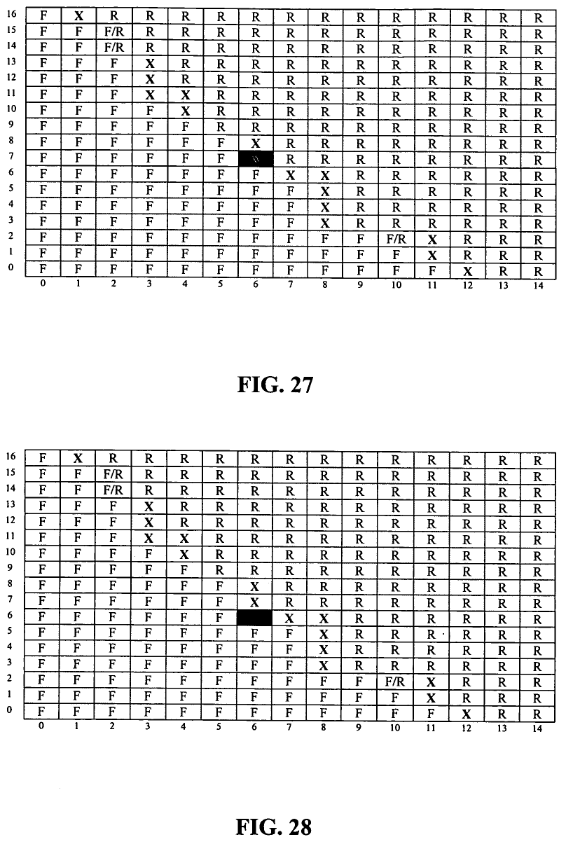

In block 1475 the counter y is decreased by 1, and in block 1463 is it then determined that y, which is equal to 6, is equal to ybot(6)=6. Thus, in block 1466 the mortgage service server 615 checks Q1(6) and Q2(6) which results in a fee that is less than the minimum provided by the broker as shown in FIG. 28. In block 1478, ybot(6) is set to y+1=6+1=7, and in block 1481 the blocks to the left of row 6, column 6 are eliminated as described previously.

In block 1484, the mortgage service server 615 returns to block 1380 in FIG. 13 and proceeds to block 1385 to increment the counter k=k+1. Then, in block 1360, the next column that is under evaluation is column 9 from FIG. 28. The mortgage service server 615 will proceed as previously described and, in this example, will evaluate column 9, column 5, column 10, column 4, column 11, column 3, column 12, column 2, column 13, column 1, column 14, and column 0 respectively.

When all of the columns are evaluated, k would be equal to k+1=7+1=8 in block 1385. In block 1360, it is determined that ymid+8 would not be less than or equal to yend(i). In block 1370, k would not be equal to 0, and in block 1375 ymid-k would be equal to −1, which is less than ybeg(i)=0. Thus all of the rate pairs for first lien Q1(i) and second liens Q2(j) will have been evaluated. In block 1390, the mortgage service server 615 will determine the best rate and fee for the Q1(i) and Q2(j) combination by comparing the stored values in Qresults. This will be stored for future use. In block 1395 the counter j would be incremented by 1 to proceed to the next second lien of Q2(j). If, as determined in block 1330, there is another second lien in Q2(j), then a process similar to that described above would be repeated for the next second lien in Q2(j).

If all of the second liens have been evaluated, then in block 1335 the mortgage service server 615 would determine the best rate and fee for the first lien in Q1(i) with all associated second liens Q2, which would be stored for future use.

In block 1340, the mortgage service server 615 will increment the counter i to proceed to the next first lien. In block 1310, if there is another first lien, the process described above is repeated for first lien Q1(i) and all associated second liens Q2. Once the best rate and fee combinations have been determined for all first liens Q1, in block 1312, the mortgage service server 615 outputs the results to the computing device 600 through the network 605. The results may be output, such as, for example, in FIG. 10 as described previously. As will be recognized by those of ordinary skill in the art, modifications may be made to the preceding exemplary embodiment. For instance, certain steps may be performed in different orders or may not be performed at all without deviating from the spirit and scope of the invention.

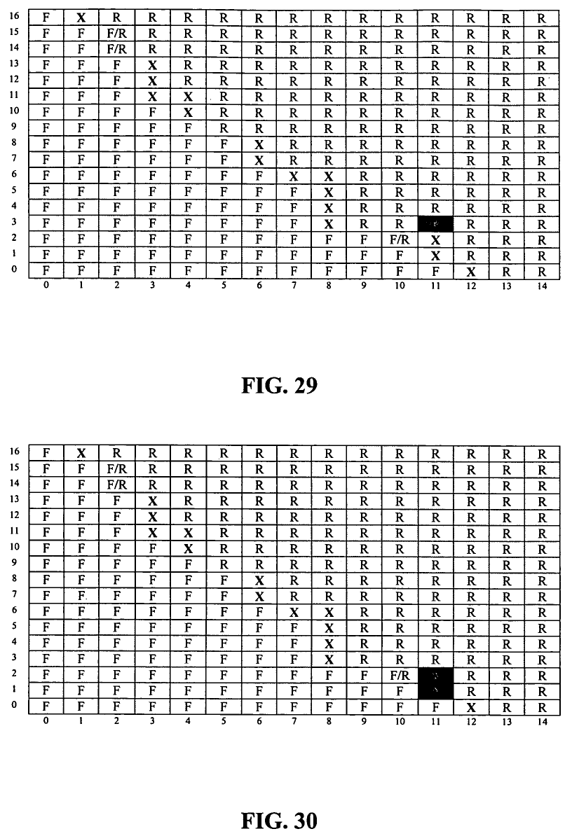

In another alternative embodiment, the algorithm provided in FIG. 13 may be modified to provide further optimization in searching. For example, after evaluating column 7 as described previously in FIGS. 17 through FIG. 21, the mortgage service server 615 may proceed to evaluate column 11 next instead of column 8. This reduces the number of calculations required because the mortgage service server 615 will eliminate more boxes that would violate the rate and payment maximum or the broker fee minimum. As shown in FIG. 29 the mortgage service server 615 could first evaluate column 11 and row 3, where xmid is set to (yend(i)+8)÷2=(14+8)÷2=11, and ymid=(6+0)÷2=3. As shown, column 11, row 3 results in a rate violation, thus the boxes above row 3 and to the right of column 11 may be eliminated as shown in FIG. 29. Then as described before the ybot is set to 2, so ymid is equal to (2+0)÷2=1. As shown in FIG. 30, column 11 and row 1 result in a qualifying combination, and the mortgage service server 615 then proceeds up the column 11 and determines that row 2 also contains a qualifying combination, and stores the result as discussed previously. The mortgage service server 615 then proceeds to row 0, as shown in FIG. 31, which results in a combination where the broker fee is less than the minimum provided by broker. As described previously, the mortgage service server 615 would then proceed to evaluate column 12, column 10, column 13, column 9, column 14, and column 8, respectively. Alternatively, further optimizations may be obtained by next evaluating column 13 and column 9, and then the remaining columns.

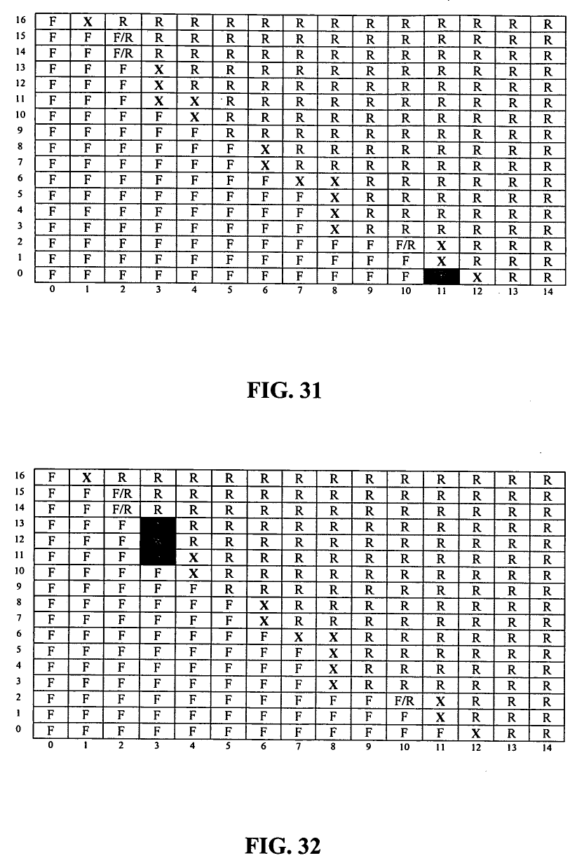

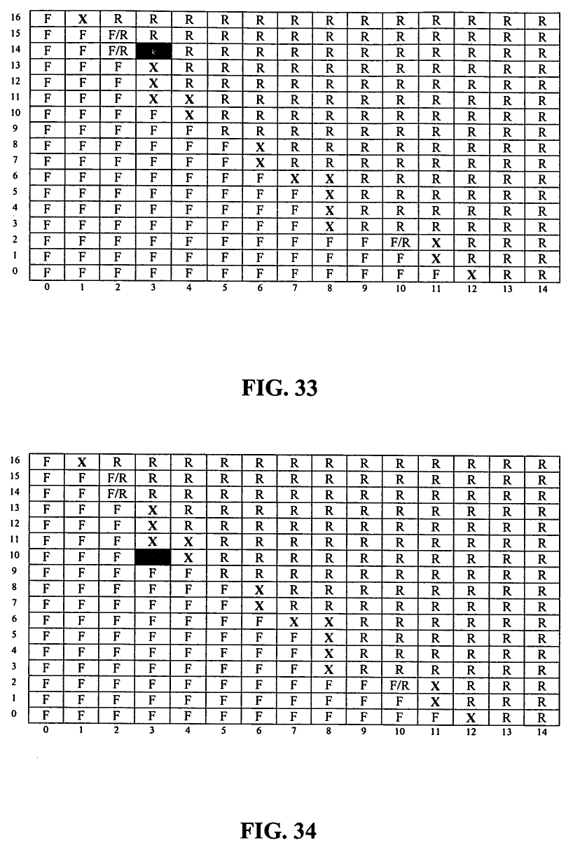

After column 8 through column 14 have been evaluated, the mortgage service server 615 may evaluate the columns to the left of column 7. As shown in FIG. 32, the new middle column xmid is equal to (6+0)÷2=3, and the ymid is equal to (16+6)÷2=22÷2=11. The mortgage service server 615 would evaluate column 3, row 11 and determine that this combination qualifies. Then proceeding as described above, the mortgage service server 615 will also determine that column 3, rows 12 and 13 both contain qualifying combinations. As shown in FIG. 33, the mortgage service server 615 would determine that column 3, row 14 is disqualified because it exceeds the rate and payment provided by the applicant. Then, as described above, and as shown in FIG. 34, the mortgage service server 615 evaluates column 3, row 10, which results in a fee that is less than the minimum provided by the broker. Thus all of the boxes below and to the left of column 3, row 10 would be eliminated (as shown in FIG. 34). Then columns 4, 2, 5, 1, 6, and 0 may be evaluated. Alternatively, columns 5 and 1 may be evaluated before the rest to obtain further optimizations.

As an alternative embodiment, software may run locally on a user machine that accepts borrower's information, periodically downloading adjustment rule updates from a lender server or network but executing all of the price and qualification calculations at the broker or user's computer. As one of ordinary skill in the art will recognize, there are many different hardware and software combinations capable of implementing the disclosure herein.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A computer usable medium having computer readable program code for determining a qualified loan applicant, the program causing one or more computers to:
receive applicant information;
receive first lien information;
determine a candidate first lien by applying said applicant information to said first lien information;
store debt-to-income-ratio requirement information associated with said candidate first lien;
determine one or more candidate second liens associated with said candidate first lien;
determine debt-to-income ratios of the combination of each candidate second lien with said candidate first lien; and
determine qualifying combinations based on whether each said debt-to-income ratio violates said stored debt-to-income-ratio requirement.

2. The computer usable medium of claim 1, wherein said program causes one or more computers to organize said candidate first liens based on common characteristics.

3. The computer usable medium of claim 2, wherein said common characteristics include the term of the loan.

4. The computer usable medium of claim 2, wherein said program causes one or more computers to output the candidate first liens based on said common characteristics with said one or more associated candidate second liens.

5. The computer usable medium of claim 1, wherein said program causes one or more computers to order the rates of the candidate first lien in an array.

6. The computer usable medium of claim 5, wherein said program causes one or more computers to order the rates of a candidate second lien in a second array.

7. The computer usable medium of claim 6, wherein said program causes one or more computers to eliminate combination of rates of said candidate first lien and said candidate second lien based on said ordering of rates of said candidate first and second liens and said applicant information.

8. The computer usable medium of claim 1, wherein said program causes one or more computers to determine a combination of said candidate first and second liens that results in the lowest total loan payment.

9. The computer usable medium of claim 8, wherein said program causes one or more computers to output said qualifying combinations with said combination of said candidate first and second liens that results in the lowest total loan payment indicated.

10. A computer usable medium having computer readable program code for displaying a group of potential first and second liens, the program causing one or more computers to:
determine candidate first liens based on applicant information and first lien information;
organize said candidate first liens based on common characteristics, including, but not limited to, the term of loan, the time the rate is fixed, or whether the loan payment is interest only for a specified period;
determine one or more candidate second liens associated with said candidate first liens; and
output the candidate first liens based on said common characteristics with said one or more candidate second liens.

11. The computer usable medium of claim 10, wherein said program causes one or more computers to determine a combination of said candidate first and second liens that results in the lowest total loan payment.

12. The computer usable medium of claim 10, wherein said program causes one or more computers to determine a combination of said candidate first and second liens that results in the lowest total loan payment and the highest broker fee.

13. The computer usable medium of claim 12, wherein said program causes one or more computers to indicate said combination of said candidate first and second liens that results in the lowest total loan payment and the highest broker fee.

14. The computer usable medium of claim 13, wherein said program causes one or more computers to order the rates for said candidate first lien and a candidate second lien in one or more arrays.

15. The computer usable medium of claim 10, wherein said program causes one or more computers to:
store debt-to-income-ratio requirement information associated with said candidate first lien;
determine debt-to-income ratios of the combination of each candidate second lien with said candidate first lien; and
determine qualifying combinations based on whether each said debt-to-income ratio violates said stored debt-to-income-ratio requirement.

16. A computer usable medium having computer readable program code for determining qualified first and second liens, the program causing one or more computers to:
receive user criteria related to a loan application;
order the rates for a candidate first lien on one axis of a first array;
order the rates for a candidate second lien on another axis of a second array;
determine whether one rate of said candidate first lien and one rate of said candidate second lien is a qualifying combination based on said user criteria; and
eliminate other combinations of rates of said candidate first lien and said candidate second lien based on said ordering of the rates for said candidate first and second liens.

17. The computer usable medium of claim 16, wherein said program causes one or more computers to determine which qualifying combination results in the lowest loan payment and highest broker fee.

18. The computer usable medium of claim 17, wherein said program causes one or more computers to output said qualifying combinations with the qualifying combination that results in the lowest loan payment and highest broker fee indicated.

19. The computer usable medium of claim 16, wherein said program causes one or more computers to organize said first and second arrays by a loan payment associated with said rates for said candidate first and second liens.

20. The computer usable medium of claim 16, wherein said user criteria includes a maximum loan payment amount and a minimum broker fee.

21. A method for determining a qualified loan applicant, comprising:
receiving applicant information;
receiving first lien information;
determining a candidate first lien by applying said applicant information to said first lien information;
storing debt-to-income-ratio requirement information associated with said candidate first lien;
determining one or more candidate second liens associated with said candidate first lien;
determining debt-to-income ratios of the combination of each candidate second lien with said candidate first lien; and
determining qualifying combinations based on whether each said debt-to-income ratio violates said stored debt-to-income-ratio requirement.

22. The method of claim 21, further comprising organizing said candidate first liens based on common characteristics.

23. The method of claim 22, wherein said common characteristics include the term of the loan.

24. The method of claim 22, further comprising outputting the candidate first liens based on said common characteristics with said one or more associated candidate second liens.

25. The method of claim 21, wherein determining qualifying combinations based on whether each said debt-to-income ratio violates said stored debt-to-income-ratio requirement includes ordering the rates of the candidate first lien in an array.

26. The method of claim 25, wherein determining qualifying combinations based on whether each said debt-to-income ratio violates said stored debt-to-income-ratio requirement includes ordering the rates of a candidate second lien in a second array.

27. The method of claim 26, wherein determining qualifying combinations based on whether each said debt-to-income ratio violates said stored debt-to-income-ratio requirement includes eliminating combination of rates of said candidate first lien and said candidate second lien based on said ordering of rates of said candidate first and second liens and said applicant information.

28. The method of claim 21, further comprising determining a combination of said candidate first and second liens that results in the lowest total loan payment.

29. The method of claim 28, further comprising outputting said qualifying combinations with said combination of said candidate first and second liens that results in the lowest total loan payment indicated.

30. A method for displaying a group of potential first and second liens, comprising:
determining candidate first liens based on applicant information and first lien information;
organizing said candidate first liens based on common characteristics, including, but not limited to, the term of loan, the time the rate is fixed, or whether the loan payment is interest only for a specified period;
determining one or more candidate second liens associated with said candidate first liens; and
outputting the candidate first liens based on said common characteristics with said one or more candidate second liens.

31. The method of claim 30, further comprising determining a combination of said candidate first and second liens that results in the lowest total loan payment.

32. The method of claim 30, further comprising determining a combination of said candidate first and second liens that results in the lowest total loan payment and the highest broker fee.

33. The method of claim 32, wherein outputting the candidate first liens based on said common characteristics with said one or more candidate second liens further includes indicating said combination of said candidate first and second liens that results in the lowest total loan payment and the highest broker fee.

34. The method of claim 33, further comprising ordering the rates for said candidate first lien and a candidate second lien in one or more arrays.

35. The method of claim 30, further comprising:
storing debt-to-income-ratio requirement information associated with said candidate first lien;
determining debt-to-income ratios of the combination of each candidate second lien with said candidate first lien; and
determining qualifying combinations based on whether each said debt-to-income ratio violates said stored debt-to-income-ratio requirement.

36. A method for determining-qualified first and second liens, comprising:
receiving user criteria related to a loan application;
ordering the rates for a candidate first lien on one axis of a first array;
ordering the rates for a candidate second lien on another axis of a second array;
determining whether one rate of said candidate first lien and one rate of said candidate second lien is a qualifying combination based on said user criteria; and
eliminating other combinations of rates of said candidate first lien and said candidate second lien based on said ordering of the rates for said candidate first and second liens.

37. The method of claim 36, further comprising determining which qualifying combination results in the lowest loan payment and highest broker fee.

38. The method of claim 37, further comprising outputting said qualifying combinations with the qualifying combination that results in the lowest loan payment and highest broker fee indicated.

39. The method of claim 36, wherein said first and second arrays are organized by a loan payment associated with said rates for said candidate first and second liens.

40. The method of claim 36, wherein said user criteria includes a maximum loan payment amount and a minimum broker fee.
